(19) United States
(12) Patent Application Publication
(10) Pub. No.: US 2020/0120050 A1
(43) Pub. Date: Apr. 16, 2020

(54) SYSTEMS, METHODS AND INTERFACES FOR PROCESSING MESSAGE DATA

(71) Applicant: Project Core, Inc., New York, NY (US)

(72) Inventors: John Jung, Great Neck, NY (US); Alfred Sutton, Brooklyn, NY (US)

(73) Assignee: Project Core, Inc., New York, NY (US)

(21) Appl. No.: 16/600,121

(22) Filed: Oct. 11, 2019

Related U.S. Application Data
(60) Provisional application No. 62/744,551, filed on Oct. 11, 2018.

(51) Int. Cl. H04L 12/58; H04W 4/12

(52) U.S. Cl. CPC H04L 51/04; G06F 3/0482; H04W 4/12; H04L 51/22

(57) ABSTRACT

Systems and methods are provided to assist in different forms of communication using messaging platforms such as email, text messaging, etc. For instance, an improved massaging platform is provided for creating better human to human communication and organization of messaging, as well as messaging involving machines. Human to human include, for example, emails, text messages, social media messages, or other forms of electronic communication from another human, which usually requires some sort of response back from another user. Aspects are provided herein for highlighting and distinguishing such forms of communication, and to provide interfaces and tools to organize and simplify such interactions.

### RELATED APPLICATIONS

This application claims the benefit under 35 U.S.C. § 119(e) of U.S. Provisional Patent Application Ser. No. 62/744,551, filed Oct. 11, 2018, entitled “SYSTEMS, METHODS AND INTERFACES FOR PROCESSING MESSAGE DATA,” the entire contents of each of which is incorporated by reference herein.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

There are many different systems for communicating between users, such as text messaging, email, among other types of systems. Many of these systems require users to manually manage, organize and maintain such communications.

### SUMMARY

Systems exist that permit users to perform messaging between one or more users, such as by using email, text messaging, among other types of messaging formats and delivery mechanisms. However, it is appreciated that many of these systems were designed non-optimally, and are thus not very user-friendly. For instance, as email has become the most pervasive form of communication, it has also become the defacto standard for exchanging files, having conversations between groups, distributing advertisements, among other forms of communication. As a result, many user's email boxes are large and hold many items, making them unwieldly to manage and use. There have been some point solutions to solve certain problems (e.g., SPAM filters), but these features require regular manual user intervention, monitoring and configuration, which is usually beyond a typical user's capability.

According to some embodiments described herein, it would be beneficial to provide an enhanced interface to email and/or other messaging systems that is easier to use by users. Such an interface, in some embodiments, may intelligently receive and process incoming messages. In some implementations, the system may be capable of organizing conversations based on the sender and recipients of a conversation.

More generally, systems and methods may be provided to assist in different forms of communication using messaging platforms such as email, text messaging, etc. For instance, as discussed herein, an improved massaging platform is provided for creating better human to human communication and organization of messaging, as well as messaging involving machines. Human to human include, for example, emails, text messages, social media messages, or other forms of electronic communication from another human, which usually requires some sort of response back from another user. Aspects are provided herein for highlighting and distinguishing such forms of communication, and to provide interfaces and tools to organize and simplify such interactions.

In some implementations as provided herein, automated tools and/or functionality is provided to assist in automating machine to human or human to machine communication. In some embodiments, an architecture and functional layer is provided that allows for these types of communications to happen in an easier way. In some embodiments, the architectural layer permits information to be aggregated (e.g., machine→human). In some embodiments, automated actions may be provided where human to machine actions taken are automated and are presented within a single interface (such as automatically checking into flights, automatically filling out certain forms on behalf of the user, clicking on email confirmations, automating returns of products, etc.).

Lastly, tools and/or functionality is provided to automate machine-to-machine communication. In some embodiments, the system architecture allow for chaining together information from various sources to complete certain tasks. Such as to perform a certain action, you might need to aggregate data automatically from two or more sources. In some embodiments, a system is provided that automatically gathers data to input to another external API or service to complete a task that was initiated by the end user.

In some embodiments, the system may be capable of processing information received in real time via messaging and other platforms to perform certain actions on behalf of a user. This information can be, for example, airline information that updates realtime gate information. This information can be, for example, data or code stored on github such as when a user pushes code, the system receives and processes realtime information regarding this pushed code. This information can be comments on social media regarding which the system receives realtime information. This information may be transmitted via an API that is provided within the system architecture, and such information may include any kind of information that can be sent in any format—the received data may be structured by the API so that it may be digested by the end user and/or operated on by downstream system elements or tools. Further, tools may be provided that permit an end user to build and/or customize their own system to notify things that are important to them via such system APIs.

In some embodiments, a system may be provided that organizes email threads based on contacts. For instance, it is appreciated that in typical email threads, multiple people may be communicating on the same thread and it is confusing for people to track which users are participating on which thread. In some embodiments, a system is provided that has an interface structure that permits a user to view messages based on groups of contacts of each message, permitting the user to locate and view messages based on who the contacts groups are in every single message.

In one implementation, a user interface permits a thread of a conversation (e.g., as identified by a subject) may be organized in another dimension by the user or users that are in the conversation thread. For instance, it may be beneficial to allow the user to view a portion of a subject-based thread where a subset of users are involved in those messages. In one implementation, these messages are organized in a container based on the user group within the thread. In some embodiments, the system may permit the user to easily detect within the interface situations where a person has been removed from (or added to) a message thread.

Because, in some embodiments, the system organizes email (or other message type) threads based on contacts, the system may be organized based on people the user has had previous conversations (e.g., people the user knows and has communicated with in the past) and those who are new people with whom the user has not previously communicated or authorized. In some embodiments, such organization may occur automatically, as messages are received and moved into different interface areas. In some embodiments, when a message is received from new people that contact a particular user, the user interface separates the message from conversation threads that the user is communicating (e.g., with known users). In some embodiments, the user interface is adapted to prompts the user whether they want to approve, ignore or block the new user. Also, in some implementations, the system is configured to detect people who you have never emailed the user previously and auto-responds on the user's behalf to let them know that the user received their email.

Also, in some instances, automated actions (one or more actions) can be chained together. For example if a company is marked as unsubscribed, but the company still sends the particular user an email, in some embodiments, the system automatically removes the subsequent email from the user's email inbox and moves it into the spam or trash folder. For a more complex example, a message regarding a flight for the user is received, the system automatically inspects the departure date which triggers a push notification at a specific time and the system gathers real time airline information and aggregates departure information. The system, still being responsive to the email message regarding the flight, then chains another automated action where an Uber, Lyft or other car pooling service is automatically scheduled for the user. Further, the system may perform one or more parallel and/or serial actions, such as automatically checking the user into the flight. In some instances, such automated actions may have user interface elements used to collect information from the user. For instance, in the case of checking the user into the flight, the user interface may present buttons where the user can add or remove bags from the system interface to complete the checkin action.

In some cases, messages may be sent to a user by a company, system, bot or other entity, and it is appreciated that a system that organizes such messages may be beneficial to the user. In particular, in some embodiments, a system may be provided that tracks new subscriptions that the user receives. Upon receiving a new subscription, the system may be configured to query the user as to whether the user approves or unsubscribes from the message prior to entering the user's inbox.

In some implementations, the system may function within a program separate from a traditional email interface (e.g., Microsoft Outlook, Gmail, Apple Mail, etc.). In other embodiments, certain functions or capabilities may be added to such programs to make them easier to navigate and use. In some embodiments, a cloud-based system may be provided that interfaces to one or more messaging platforms (e.g., email, SMS, or other platform) for the purpose of receiving messages from multiple channels and organizing them within a single interface. In such a system, messages may be received and processed using a single network-based system that communicates using standard protocols to traditional messaging platforms.

In some embodiments, a single user interface is provided for the user to access the multiple message formats. In some embodiments, the interface organizes communication to a contact within a single view including the multiple message format types. In some implementations, the system is backwards compatible with email systems in that messages originated within the single user interface are sent back through the messaging platform from which the original message originated. For instance, in a one conversation between a first and second user via traditional email, the message is sent to the other user via the email platform.

In some embodiments, the system is capable of detecting whether the sender and receiver are the same messaging platform, and may communicate directly using an “enhanced” messaging where messages are sent directly between the enhanced platforms. In some implementations, to be backwards-compatible between messaging platforms, an additional message is communicated using the email, SMS, iMessage or other standard messaging platform. For instance, enhanced messages may be communicated directly between clients on the enhanced platform, while a standard email, SMS, iMessage, etc. is also communicated through traditional platforms. Information relating to enhanced functionality between client systems may be communicated in a separate channel which is separate from the traditional message routing architecture and message format, yet the enhanced system may still reference between the enhanced data and traditional message. In some embodiments, enhanced messaging information may be encoded within one or more portions of a standard message, and such information may be decoded by an enhanced messaging client system. In some embodiments described herein, an enhanced messaging client is referred to as a “June” client, and enhanced communications between clients are referred to as “June-to-June” communication.

Further, in some embodiments, the enhanced messaging system is capable of communicating between a sender and receiver using several different channels. For instance, the system may be capable of determining that a particular contact is reachable using several different communication channels or methods, including traditional email, SMS, iMessage, etc. Further, the system may be capable of determining that a particular contact is using the enhanced communication platform, and displays a user-user status in some embodiments (e.g., a particular contact is online and using the enhanced platform). In some embodiments, if the sender and receiver are both using the enhanced communication platform, the sender may be capable of sending a direct message using the platform, even though the receiver may be reachable via standard communication channels (e.g., email, SMS, etc.). To this end, the system may store hierarchical information regarding communication preferences to one or more contacts. In some embodiments, because the enhanced communication platform monitors activity on that platform, the system may selectively use communication channels based on the receiver's activity (e.g., send a direct message using the enhanced platform as the receiver was active within the last few minutes).

Further, according to various embodiments, it is appreciated that traditional messaging platforms are designed to receive and see all messages, but with many contacts, conversations, and advertisements, it becomes difficult to discern between communications that are desired (e.g., valid conversations) and the remaining information that may be communicated to a user's inbox, for example. To reduce the “noise” experienced by users, according to some embodiments, the system may be provided that automatically distinguishes between conversations and non-conversation messages without prior configuration by a user. For instance, the system may track conversations and present them in a different area of the user interface, versus other message types such as ads, subscription messages, news feeds, etc. In one configuration, the system may be configured to detect conversations separate from other types of message, but within the interface, allows the user to receive notifications for only conversation messages and not all messages that are received. In this way, the amount of noise experienced by the user is reduced.

In some embodiments, a “favorites” tool or window is provided that permits a user to easily access their favorite contacts (e.g., within a single interface view). Unlike traditional email, SMS, iMessage interfaces, they require a user to traverse multiple input steps to see and view messages received through traditional messaging protocols. According to one embodiment, a system and interface is provided that allows a user to add favorites to access all communication from a contact within one singular view. For example, a contact may have multiple channels of communication with a contact and they may all be accessible within a single view. In this way, there are less user interface steps required to view notifications and access the variety of messages that a user may receive.

In some embodiments, an automated tool is provided via a messaging system that allows for automated introductions to third party contacts. For example, in one instance a user A would like to be introduced to a user C via an introduction by a user B. For instance, a message may be sent from a user A asking a user B, to introduce them to a user C. In one aspect, the messaging system may include one or more components that automatically perform one or more of the connections that reduce the number of user operations necessary to establish the connection. In one embodiment, the messaging system receives the request and sends a message to the third user (e.g., user C) to accept the connection to the first user and send an introductory email, without the second user needing to perform a user operation. In some embodiments, the message may include a link that when selected by the third user, causes the system to send the introductory email. In some aspects, the messages may include emails, but it should be appreciated that other message types and systems may be used.

According to one aspect, a system is provided. The system comprises a messaging platform adapted to communicate with one or more message sources, the messaging platform being configured to identify, within the user interface, a plurality of messages in a container based on contact information.

According to one embodiment, the messaging platform being configured to identify, from a message stream, a source of an identified message associated with a conversation with an identified user. According to one embodiment, the messaging platform is configured to automatically place the identified message in a container based on contact information of the source without any prior user configuration. According to one embodiment, messaging platform being configured to identify, from a message stream, a source of an identified message associated with a conversation with at least one of a plurality of users and wherein the messaging platform is further configured to identify whether, within a later-sent message within a thread of messages related to the identified message, whether a user was added or deleted to the later-sent message.

According to one embodiment, the messaging platform is configured to discern, from a message stream, a source of an identified message associated with a conversation with an actual person and wherein the messaging platform is configured to automatically place the identified message in a container based on contact information of the source without any prior user configuration. According to one embodiment, the identified message has a first group listing that identifies users identified in the conversation, and wherein the wherein the messaging platform is configured to automatically place the identified message in a container associated with the particular identified users in the conversation. According to one embodiment, in response to receiving a subsequent message in the conversation, wherein a list of identified users that receives the subsequent message is modified, the messaging platform is configured to automatically place the subsequent message in a different container associated with the modified list of users in the conversation. According to one embodiment, the messaging platform is configured to identify a message originating from a user not previously identified to the system, and in response to the identification, placing the message in a portion of the interface separate from conversations with known users.

According to one embodiment, the messaging platform is configured to respond with an automated message to the user not previously identified to the system. According to one embodiment, the messaging platform is configured to track subscriptions to message distributions for a receiving user. According to one embodiment, the messaging platform further comprises a component that is adapted to query the receiving user prior to placing a subscription-based message within a mailbox of the receiving user. According to one embodiment, the messaging platform further comprises a user interface, responsive to receiving a subscription-based message, queries the receiving user whether the user approves or unsubscribes from the subscription-based message. According to one embodiment, the messaging platform further comprises a component configured to determine a common communication channel between a first client system and a second client system among a plurality of available communication channels. According to one embodiment, the plurality of communication channels include at least one of a group comprising an email channel, an SMS channel, an iMessage channel, and an enhanced communication platform channel.

According to one embodiment, selection of a channel among the plurality of available communication channels is based, at least in part, on a stored configuration related to a user to which the first client system communicates with the second client system. According to one embodiment, wherein the stored configuration is stored in a memory associated with a user of the first client system. According to one embodiment, the messaging platform is configured to identify, from a message stream, messages that are conversational from messages that are non-conversational. According to one embodiment, the messaging platform is configured to identify, from the message stream, messages that are conversational from messages that are non-conversational without prior user configuration. According to one embodiment, the messaging platform is configured to perform an automated introduction to a third party contact. According to one embodiment, the messaging platform is configured to perform the automated introduction to the third party contact responsive to an email message between a first user and a second user. According to one embodiment, the messaging platform is configured to send, responsive to the email message between the first user and the second user, a message to the third party contact to accept the introduction. According to one embodiment, the messaging platform is configured to send an introduction message responsive to an indication that the third party contact accepts the introduction.

According to one aspect, a method is provided. The method comprises providing, in a messaging platform adapted to communicate with one or more message sources, the a system component that identifies, within the user interface, a plurality of messages in a container based on contact information.

According to one aspect, a computer-readable medium, that when executed on a processor, performs a method is provided. The method comprises providing, in a messaging platform adapted to communicate with one or more message sources, the a system component that identifies, within the user interface, a plurality of messages in a container based on contact information.

According to one aspect, a system is provided. The system comprises a messaging platform adapted to communicate with one or more message sources, the messaging platform being configured to identify, from a message stream, a source of an identified message associated with a conversation with an identified user and wherein the messaging platform is configured to automatically place the identified message in a container based on contact information of the source without any prior user configuration.

According to one aspect, a system is provided. The system comprises a messaging platform adapted to communicate with one or more message sources, the messaging platform being configured to identify, from a message stream, a source of an identified message associated with a conversation with at least one of a plurality of users and wherein the messaging platform is further configured to identify whether, within a later-sent message within a thread of messages related to the identified message, whether a user was added or deleted to the later-sent message.

According to one aspect, a system is provided. The system comprises a messaging platform adapted to communicate with one or more message sources, the messaging platform being configured to discern, from a message stream, a source of an identified message associated with a conversation with an actual person and wherein the messaging platform is configured to automatically place the identified message in a container based on contact information of the source without any prior user configuration. Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “ this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 shows a block diagram of a distributed computer system capable of implementing various aspects in accordance with some embodiments of the technology described herein;

FIG. 2 shows an example architecture of a messaging platform in accordance with some embodiments of the technology described herein;

FIG. 3 shows an example message handling process in accordance with some embodiments of the technology described herein;

FIG. 4 shows an example message thread handling process in accordance with some embodiments of the technology described herein;

FIG. 5 shows an example computer-implemented process for handling messages in accordance with some embodiments of the technology described herein;

FIG. 6 shows another example computer-implemented process for handling messages in accordance with some embodiments of the technology described herein;

FIGS. 7-19B shows example user interfaces in accordance with some embodiments of the technology described herein.

### DETAILED DESCRIPTION

According to one implementation, a system is provided that is easier for users to view, locate, and/or respond to messages received from one or more users, companies, or other entities. As discussed, it is appreciated that there are difficulties experienced by users of traditional messaging platforms, in that they experience noise from the various sources of data, and it becomes difficult to find and view necessary messages. To this end, according to various embodiments, an enhanced interface is provided to email and/or other messaging systems that is easier to use by users. Such an interface, in some embodiments, may intelligently receive and process incoming messages. In some implementations, the system may be capable of organizing conversations based on the sender and recipients of a conversation.

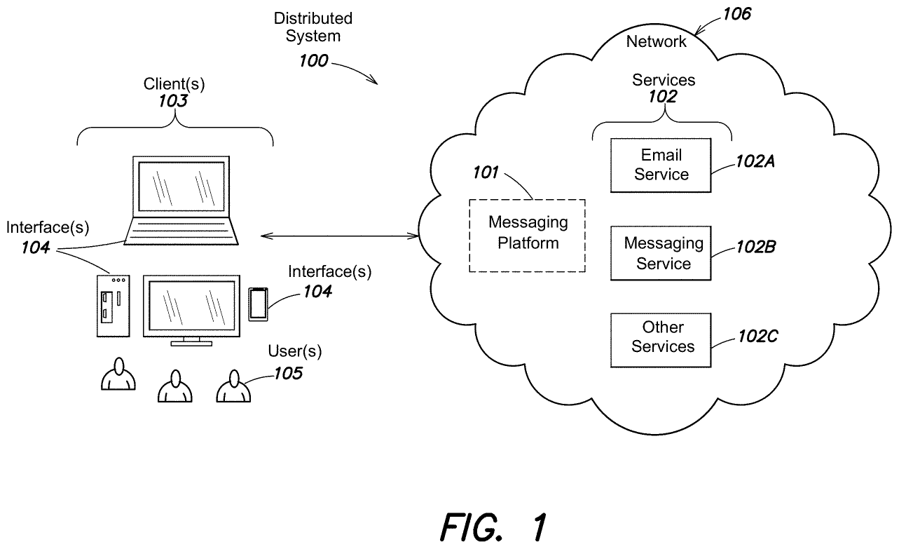

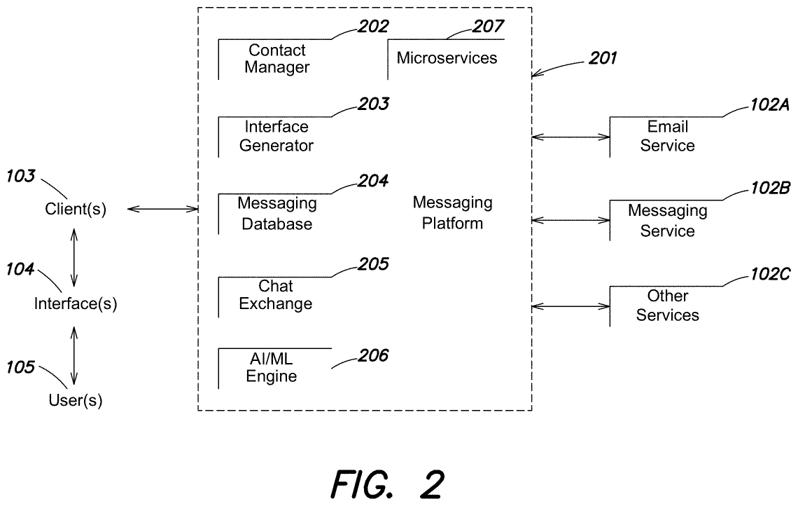

FIG. 1 shows a block diagram of a distributed computer system 100 capable of implementing various embodiments as discussed herein. In particular, distributed system 100 includes one or more computer systems operated by users (e.g., users 105) that are coupled through a communication network (e.g., network 106, including LANs, WANs, cell networks, the Internet, among others). Generally, users may access the distributed system through a client application that is executed on one or more end systems (e.g., clients 103). End user systems may be, for example, a desktop computer system, mobile device, tablet or any other computer system having a display. Also, various embodiments herein may be implemented as hardware, software, or combination thereof.

As discussed, various aspects relate to interfaces through which the user can interact with a distributed computer system. To this end, users may access the distributed computer system via the end user system (e.g., clients 103). According to some embodiments, one or more users (e.g., users 105) interact with one or more client systems (e.g., clients 103) via one or more interfaces (e.g. interfaces 104) for the purpose of receiving and managing messages see from one or more services (e.g., services 102).

For instance, the user may receive one or more messages from an email service 102A, a messaging service 102B, or any other type of service (e.g., other services 102C) that is capable of generating one or more messages for a user. As discussed above, it would be beneficial to provide an enhanced interface to email and/or other messaging systems that is easier to use by users. In some embodiments, a messaging platform 101 is provided that is capable of integrating with one or more message services (e.g., services 102) for the purpose of allowing a user to manage their messages, review messages, and to generate messages to other users.

FIG. 2 shows an example architecture of a messaging platform in accordance with some embodiments of the technology described herein. In particular, FIG. 2 shows aspects of a messaging platform (e.g., messaging platform 101) according to various embodiments as described herein. As shown, a messaging platform 201 may be provided that includes one or more components. Such components may be, for example, processes, servers, services, or any combination thereof that may be communicated with over one or more communication networks (e.g., network 106). It should be appreciated that these components may provide individual functions and/or may be combined with any other component.

Messaging platform 201 may include a contact manager 202 which is capable of recording in managing contacts and their associated information relating to the user's account. For instance, in one embodiment, the user may have a separate account with the messaging platform that permits the user to manage communications with one or more servers, platforms, or other messaging entities. In some embodiments, contact manager 202 may create unique contact identifiers associated with each contact, and contact manager may consolidate contact information for other users under a single contact.

Platform 201 may also include an interface generated 203 that is capable of generating one or more user interfaces that can be displayed to one or more users through one or more clients. Such an interface generated 203 may be capable of rendering different areas of the interface for different types of contacts, highlighting important conversation information, filtering less important information, among other functions.

Platform 201 may also include a messaging database 204 that stores information associated with messages received from one or more services (e.g., email service 102A, messaging service 102B, or other services 102C). Messaging database 204 may include actual message data from one or more messages, pointers to messages stored within any number of services, along with any information provided by the enhanced platform, such as data cleaning and/or augmentation functions that improve the messages, or any other information.

Platform 201 may also include a chat exchange component 205 that controls communication for direct chat communication within the enhanced platform. As discussed above, it may be beneficial to permit clients that implement an enhanced messaging ability to communicate directly. For instance, for messages that do not originate within outside services substance as an email service (e.g., email service 102A), it may not be necessary to send a message through an email channel to another server, and then be sent on to a secondary messaging client. According to one embodiment, chat exchange component 205 may include additional functionality beyond that which is available in typical chat clients, including but not limited to, the ability to conduct real time chat communications with latencies under 100 ms or less, the capability to edit messages, the ability to concatenate messages of different formats (e.g., chat and email messages) into a single message within a thread, the ability to detect availability of the user within one or more channels of the multichannel contact, among other increased capabilities. As a result, the capability of communicating between contacts and the number of communication options is increased.

Platform 201 may also include an artificial intelligence (AI)/machine learning (ML) engine that has the capability for, among other functions, more intelligently handle incoming messages, determine/classify the sender of particular emails or messages, automatically generate code from emails or webpages, dynamically generate emails, predicts user behavior, redesign webpages, generate APIs, navigate webpages, make orders, or perform other functions. Although it should be appreciated that artificial intelligence may be used to perform one or more functions, it should be appreciated that any number of automated actions may be performed by component 206 including, but not limited to, functions or actions created using a combination of rules, computer vision, natural language recognition processes, machine learning, automated headless browser technology, or any number of other intelligent programming methods. Further, system 201 may include a number of other services (e.g., via microservices component(s) 207) that may perform operations based on received messages from one or more third-party services. Such services may range for example, from handling of messages, formatting of emails, performing one or more automated processes, such as the creation of webpages mapping of APIs, or other functions in relation to the received messages.

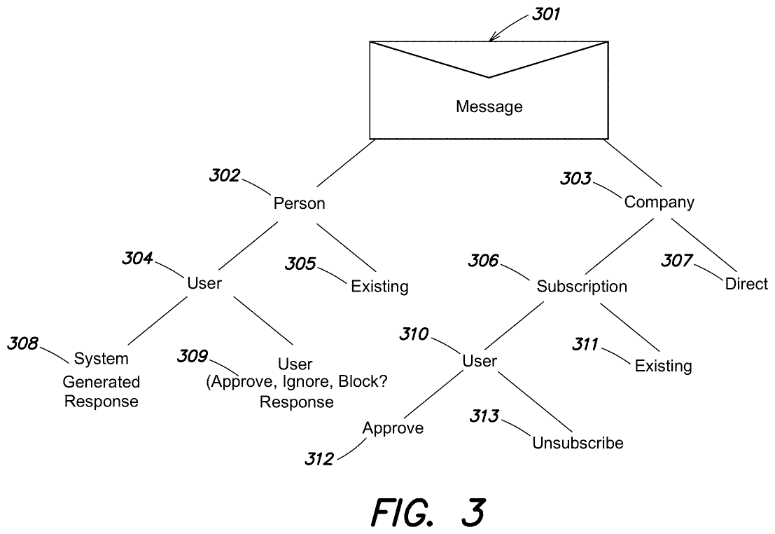

FIG. 3 shows an example message handling process in accordance with some embodiments of the technology described herein. In particular, FIG. 3 shows a possible process for handling a received message 301 as it is received from one or more services (e.g., email service 102A, messaging service 102B, or other messaging service 102C). The process may be performed, for example, by a messaging platform as discussed above (e.g., messaging platform 101, messaging platform 201, etc.).

In some embodiments, the system (e.g., the messaging platform) is configured to determine whether a received message originated from another human (e.g., a person 302) or is one that originated from a machine on behalf of an entity other than a person (e.g., a company, bot, advertiser, or other non-person entity). In one implementation, messages may be passed through a neural network or other AI/ML engine to make this determination. Further, the system may be configured to determine whether the person is a new user (e.g., new user 304) or an existing user (e.g., existing user 305). For example, an existing user may be defined as user to whom user has previously communicated with in a conversation. For example, user may have either initiated a communication to the user, we have opted in that user from a previous contact (e.g., via an approved user list), or may have approved communication with the user to some other channel (e.g., texted that user).

In some embodiments, the messaging platform may be configured to generate automatically to the new user, a message indicating that, for example, that the receiving user will reply to the message after review. Notably, messages from the user's may be handled by the system and placed in a different portion of the user interface so as to reduce the number of messages to be reviewed in a main portion of the interface. If the messages from existing user, i.e. a person that has been communicated to the user previously, the message may be placed within a contact element displayed within the interface of the client program. For example, a message received from user B may be placed within a contact for user B on user A′s interface. User A′s interface may list a variety of existing contacts from home user A may receive messages. For messages whose originating users are not existing, the receiving user may be provided an interface option to approve, ignore or block that user's messages (e.g., at 309). In this way, the system may automatically prompt the user to handle certain messages as they are received and define handling procedures as the system operates.

If the received message does not originate from an actual user, the system may process messages according to different logic. For example, as shown in FIG. 3, the system may determine whether or not the message is of a type that is associated with a subscription (e.g., subscription 306). For instance, in the case of messages whose receipt can be controlled by selective opting in, the system may process the message and determine that the message is of this type. If the message is a subscription-based message, the system may further determine whether it is an existing subscription (e.g., existing subscription 311) or a new subscription (e.g., new subscription 310). In some embodiments, if the message is associated with a new, unrecognized subscription, the user may be prompted to approve (312) or unsubscribe (313) from future messages originated from the sender. Further, subscriptions and/or company-related messages may be separated within the interface from messages associated with valid conversations, further making the interface more usable and reducing message noise. Also, there may be some messages (e.g., direct 307) messages that do not provide an unsubscribe option. These types of messages, in some embodiments, may be dealt with similarly to other types of users (e.g., a new user contact).

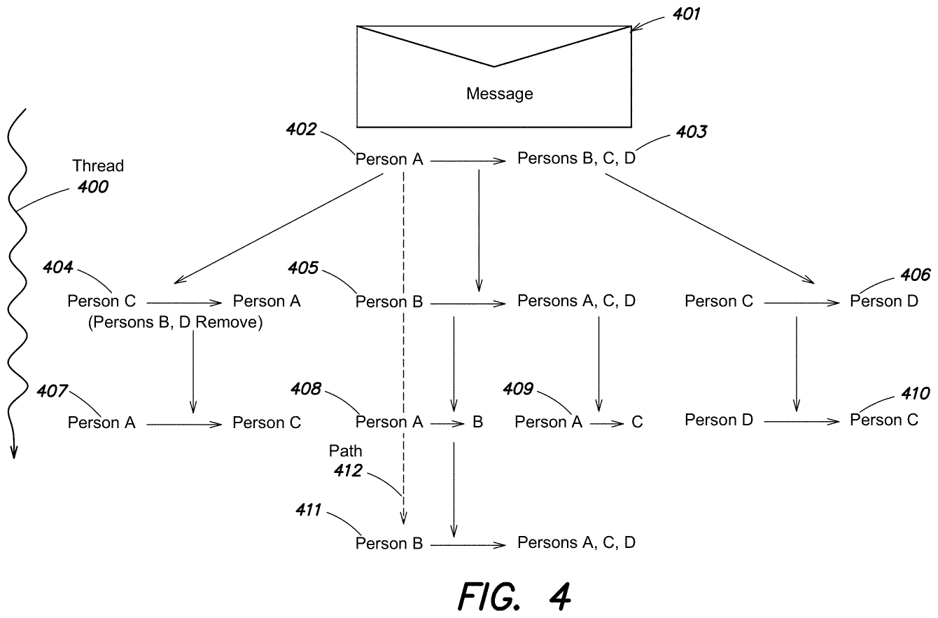

FIG. 4 shows an example message thread handling process in accordance with some embodiments of the technology described herein. In particular, FIG. 4 shows a possible process for handling a received message 401 as it is received from one or more services (e.g., email service 102A, messaging service 102B, Application Process Interface (API) services, or other services 102C). The process may be performed, for example, by a messaging platform as discussed above (e.g., messaging platform 101, messaging platform 201, etc.). The process may be performed by other external services such as webhooks, websockets, or other information that gets sent by any external services that send information to system servers as described herein (e.g., June.ai servers).

For example, message 401 may, at least initially, involve sending the message from a sender (Person A 402 in the example) to one or more recipients (Persons B, C, and D in the example). In some embodiments, it is appreciated that it would be helpful to have the capability of discerning, within the user interface, messages associated with different conversation threads. As can be appreciated, practically, any one of the recipients (and even the originator) may be capable of responding to any of the messages. Further, in their responses, one or more persons from the conversation may be dropped from the contact list in one or more threads. In some embodiments, it may be appreciated that it would be helpful to track when persons are being added/dropped from conversations, and thus a system is described herein that tracks messages in a conversation in a thread (e.g., thread 400) as users are added/subtracted from related conversations. In conventional email systems, it is appreciated that emails are generally threaded in a linear fashion based on the time at which the message was received. However, according to some embodiments, message threads are identified in sub-threads. The new sub-thread is referred to herein as a “spool” which is a subset of threads (e.g., as organized by subject and/or part of a conversation) but is also based on the participants.

In the example, above, it is appreciated that in a response message 404, a Person C may respond only to Person A (Persons B, D are removed from the conversation). Accordingly, the system may be configured to track a new fork from the existing thread and permit the user to see “side” conversations (or spool) occurring between a subgroup of the original participants (e.g., Persons A and C). This may be shown, for example, within a separate portion of the interface. In some embodiments, a new “user” may be created for the distribution list associated with the side thread. In some embodiments, a unique thread identifier may be used to track messages belonging to the spool, similar to belonging to the same room. By identifying and organizing messages based on spools, the user may more easily locate and interact with such messages.

In another example message 405, Person B may communicate to the entire distribution, and the follow-up message may be tracked on the same user associated with the full distribution. In later/other conversations (e.g., messages 408, 409, 411, 406, 410, etc.), users may be added/dropped from the conversation, and new distribution threads may be tracked. In some embodiments, the system tracks a path (e.g. path 412) through a thread, tracking users as they are added/subtracted from conversations. This path may be used to create the user interface, allowing the user to more quickly locate conversations and view messages within such conversations or spools based on both the user group and thread.

In some other interface types, all conversations between subsets of users may be seen regardless of threads (e.g., in a construct referred to herein as a “rolodex”). For instance, all conversations between Person A and Person B may be viewed and located within a designated section of the interface (e.g., a message area showing messages to/from Person B, if Person A is the user of the messaging platform and it is their account that is being shown in the interface). As referred to herein, the interface may show all messages to/from the user (e.g., Person B), allowing the user (Person A) to more easily locate information related to that communicating user. In one specific example, there may be a user interface control that permits the user to locate all files sent from that user (to the account-holding user). It may also be the case where the interface groups all the messages to/from a Person or Company within a given date range (today, yesterday, last week, last month or last year). For example, all the messages that were recently sent by a company where there are a lot of messages are grouped together by that contact today and the user is able to perform batch actions on them (mark them all as read, move them all to a folder, archive or delete them).

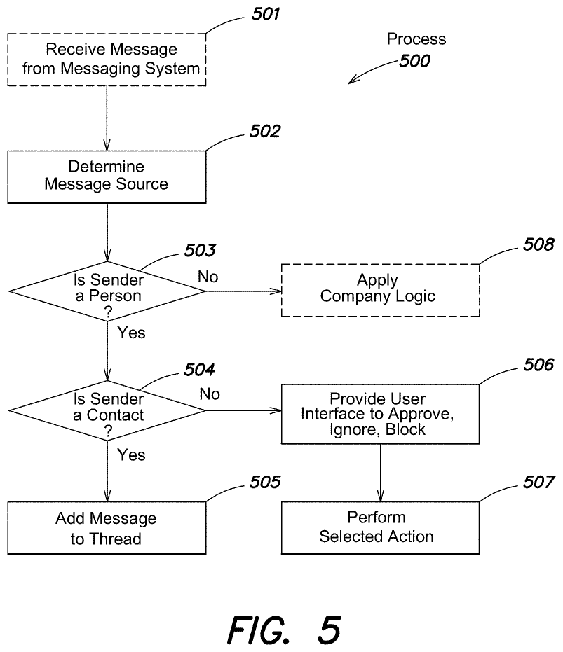

FIG. 5 shows an example computer-implemented process 500 for handling messages in accordance with some embodiments of the technology described herein. For example, one or more aspects may be performed by a messaging platform as discussed above. At block 501, the system (e.g., the messaging platform) receives a message from the messaging system. As discussed, the system may use the message source (e.g., a person, a company, etc.) as a primary index for determining how the message is handle and displayed to the user within the interface. At block 502, the system determines the message source.

At block 503, process 500 determines whether the sender is a person. If the sender is not a person, the system may apply company (or other entity) logic at block 508. If the sender is a person, at block 504, process 500 determines whether the sender is an existing contact. If so, the message is added to the proper thread within the interface (e.g., within a thread indicated by the sending user). If the sender is not an existing contact (e.g., at 504) then the system may provide a user interface wherein the user may approve, ignore or block the unknown sender user from further conversations. At block 507, the system may perform the selected user action.

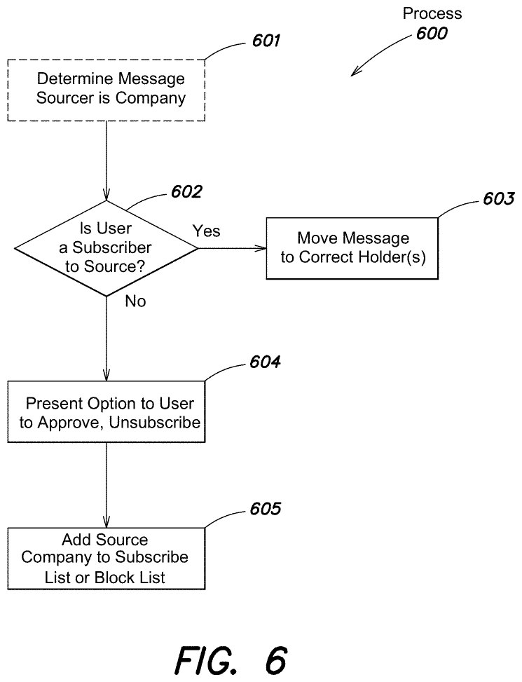

FIG. 6 shows another example computer-implemented process 600 for handling messages in accordance with some embodiments of the technology described herein. At block 601, the system determines that the message source is from a company or some other entity that is not an actual person (e.g., a bot). At block 602, the system determines whether the user is a subscriber to the source of the received message. If not, at block 604, the system presents an option to the user to prove or unsubscribe to the particular sender. Based on the user selection, system may add the source company to the subscribed list or add them to a block list if the user decides to unsubscribe to a particular source. If, it is determined at block 602 that user is a subscriber to the source, the system moves the message to the correct holder at block 603. The holder may be, for example, in item within the user interface which holds messages associated with subscriptions and/or company communication. The system may further refine recognition of such messages to particular types of senders, unsolicited advertisements, or other types of messages based on the source, content of the message, categorizations provided by other user types, among other actions.

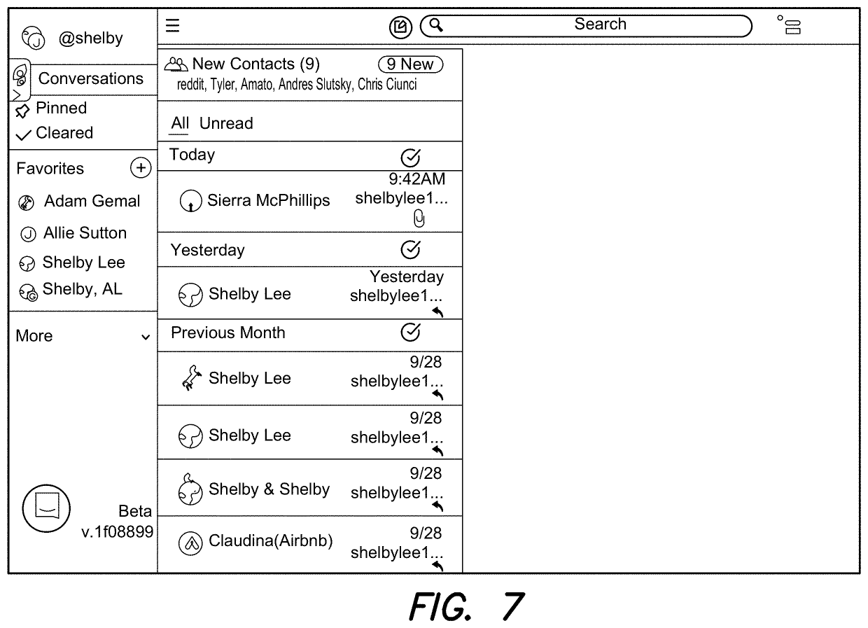

As discussed, various aspects relate to improved user interfaces for handling and displaying messages to a user. FIGS. 7-12 show example user interfaces in accordance with some embodiments of the technology described herein. In particular, FIG. 7 shows one example of a user interface according to various embodiments. The interface includes one or more areas, including the leftmost area where conversations shown. When selected, in a second interface, a number of contacts that are existing are shown. They may be organized based on last contact, such that more active and recent conversations may be easily located within the interface. A “New Contacts” control may allow the user to see contacts that are not yet on that users approved contact list.

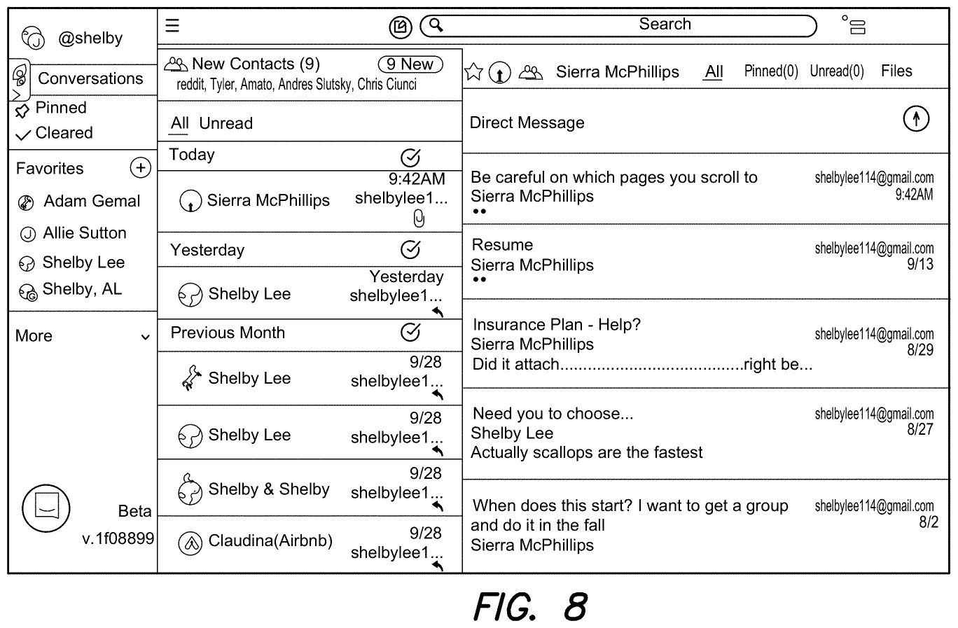

FIG. 8 shows the display after a recent contact has been selected, and a new interface is shown with all communications with that particular contact displayed within the interface. So, in one example implementation, the user interface is provided that allows the user to quickly locate all messages received from a particular user. Notably, a new contact may be created where the distribution includes more than one user within the conversation.

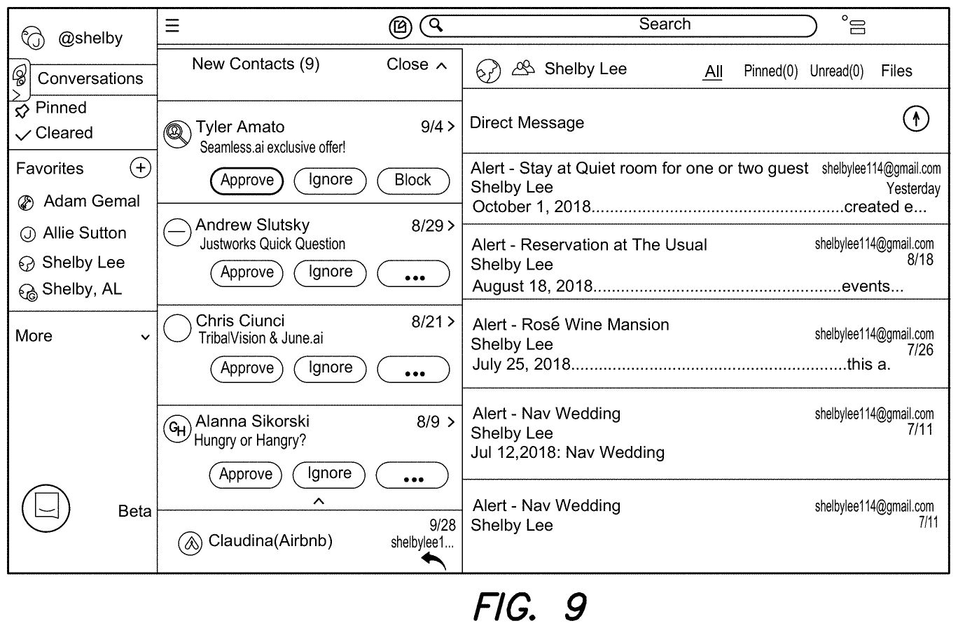

FIG. 9 shows an interface wherein the “New Contacts” option is selected and the user is allowed to approve, ignore, or block communications from the user. Because messages associated with new contacts are directed to different containers, the amount of “noise” messages is reduced. If approved, a “New Contact” may be added to the approved list and shown within the “Conversations” interface.

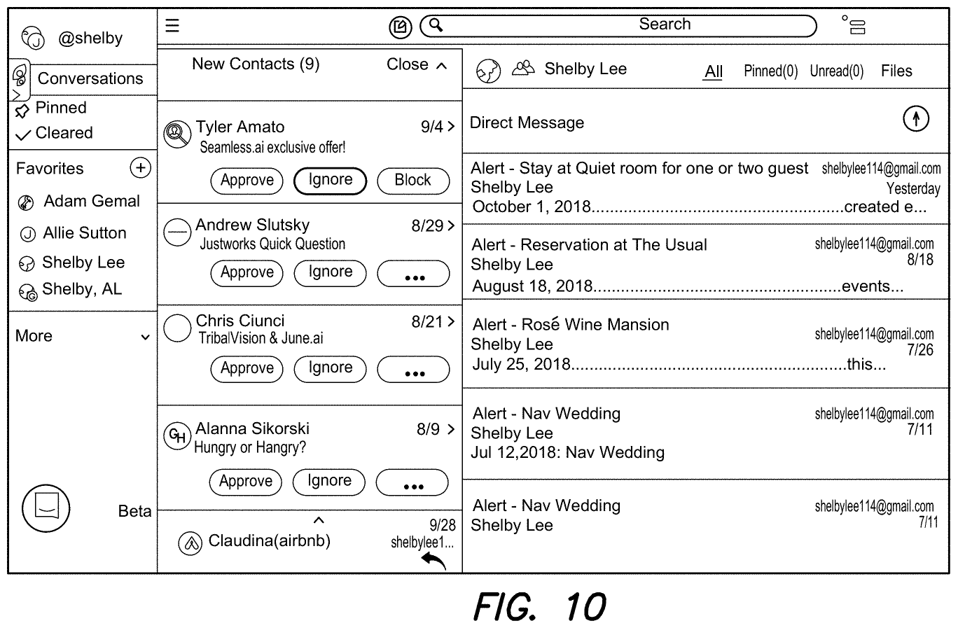

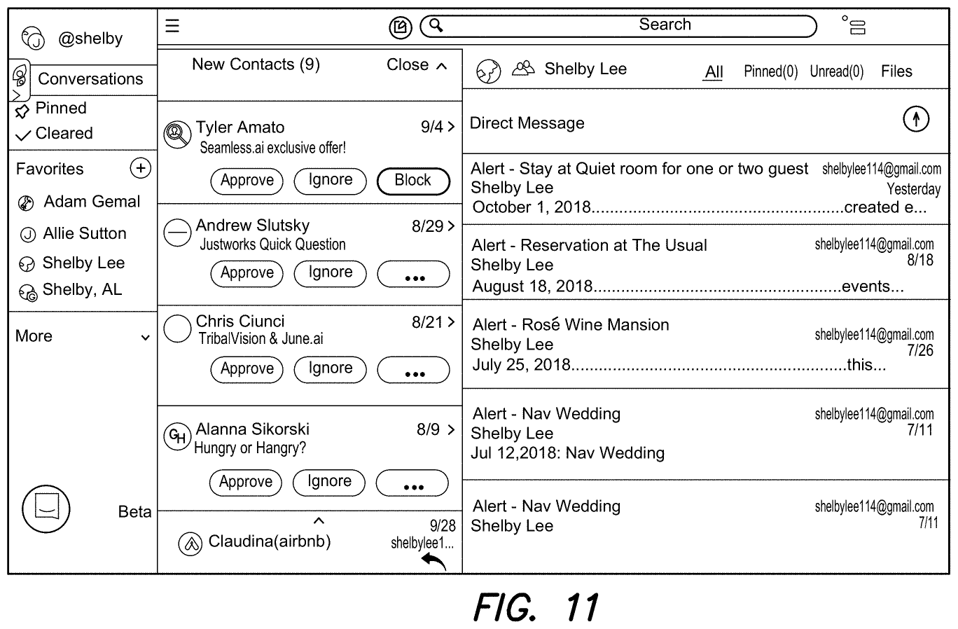

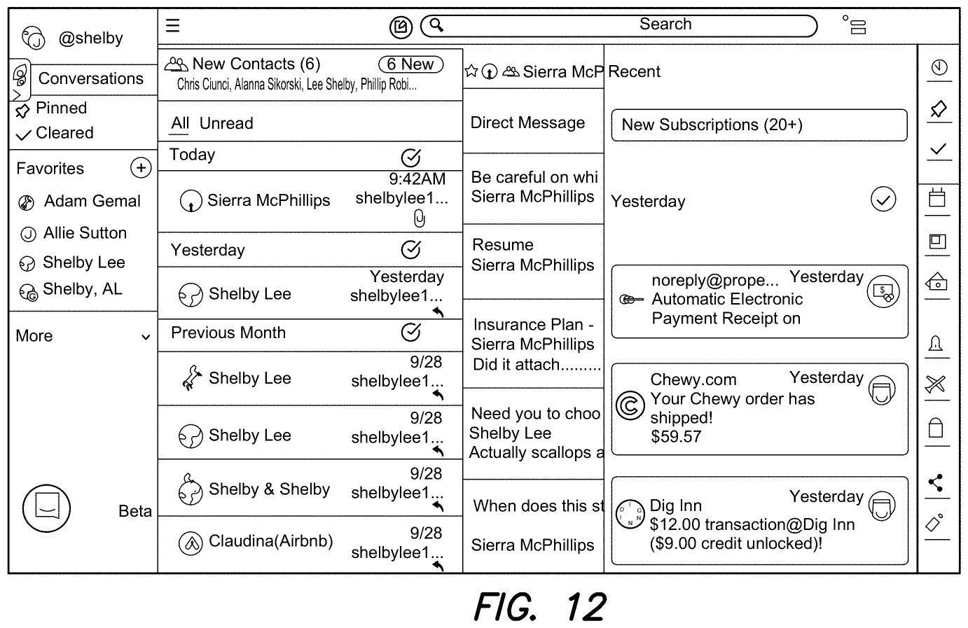

FIG. 10 shows an interface where wherein the “New Contacts” option is selected and the user selects to ignore the new contact. When selected, the current message received by the user is ignored (e.g., filtered, placed in trash, etc.). Future messages may also appear within the New Contact area. FIG. 11 shows an option that permits the user to permanently block the contact from sending messages in the future. In another interface as shown in FIG. 12, subscriptions received by the user (e.g., messages from companies, bot, ads, etc.) may be displayed in a separate area. In this area, current approved subscriptions may be listed along with their messages. In one example, the subscription is listed as a contact, and when selected, the messages received from that contact me be shown. In this way, subscription messages are removed from the main interface but are more easily locatable using a contact-based interface.

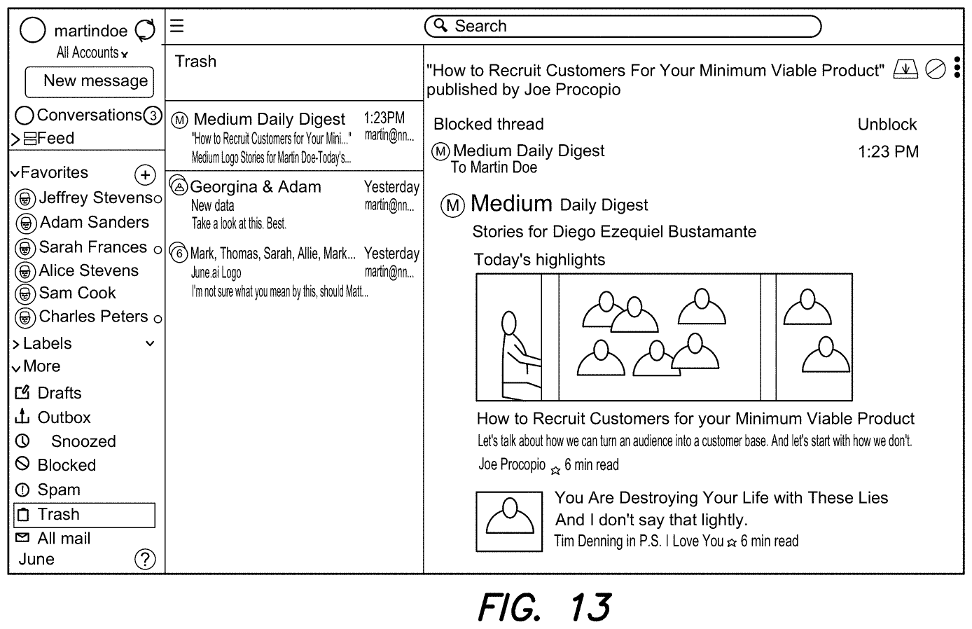

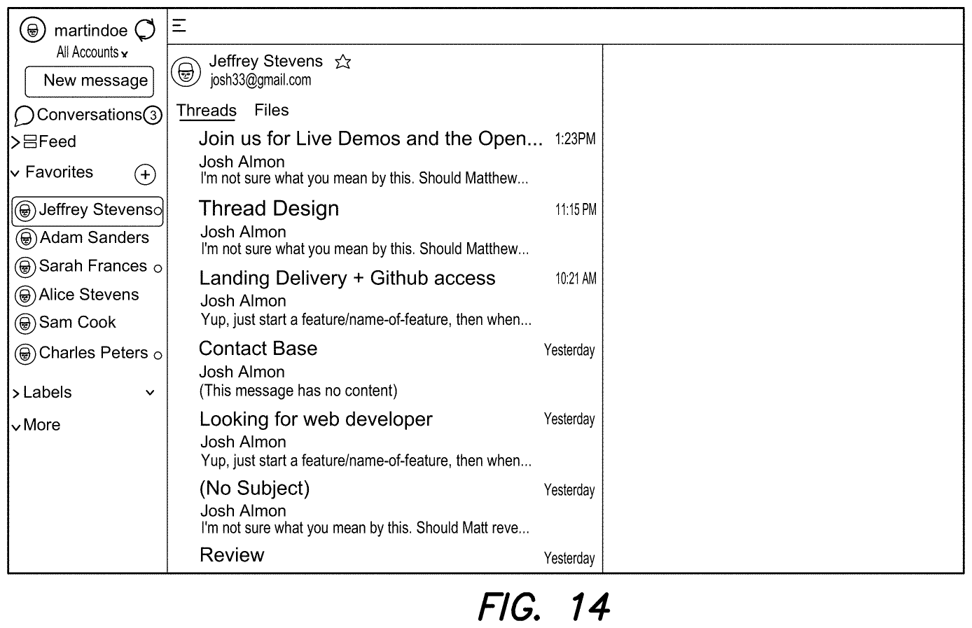

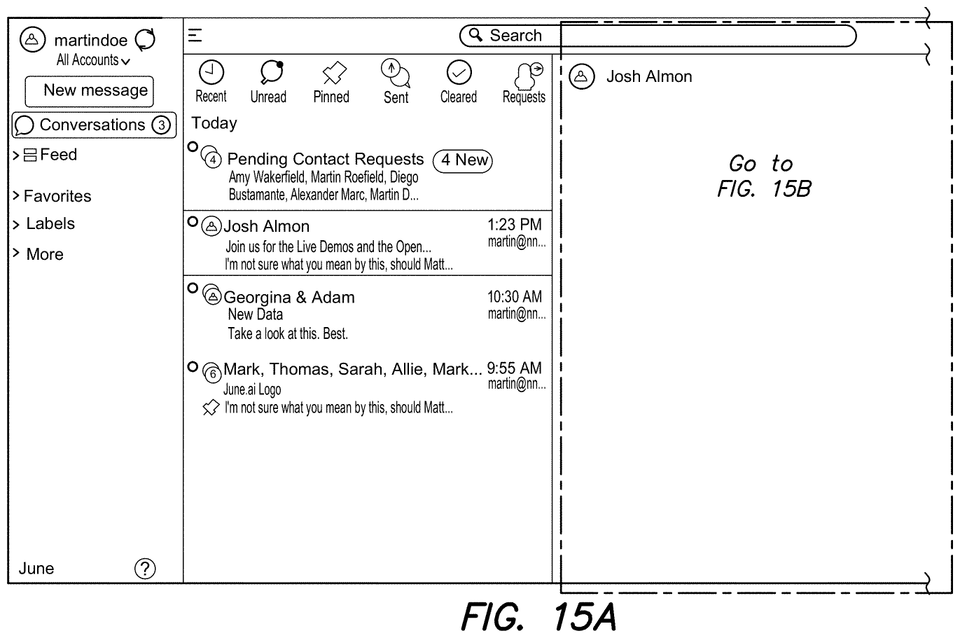

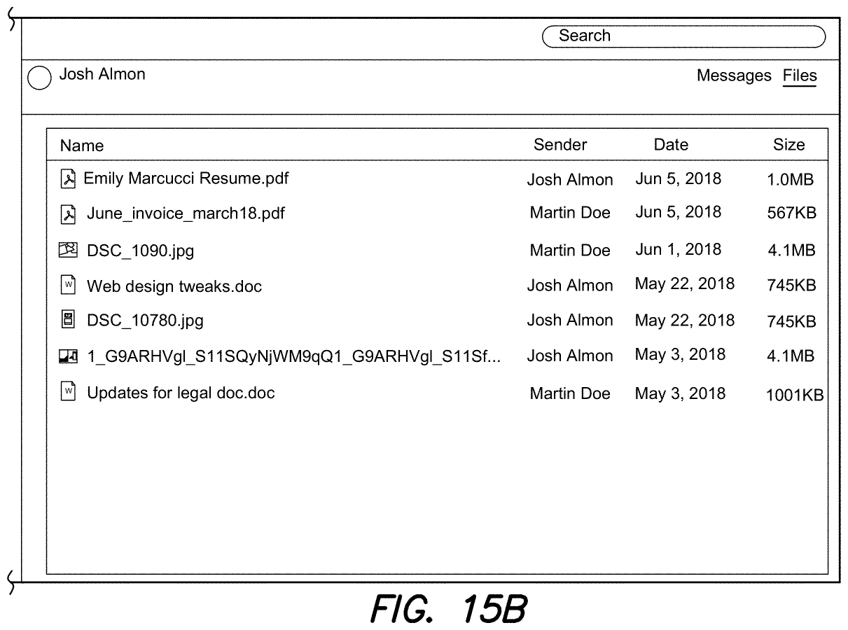

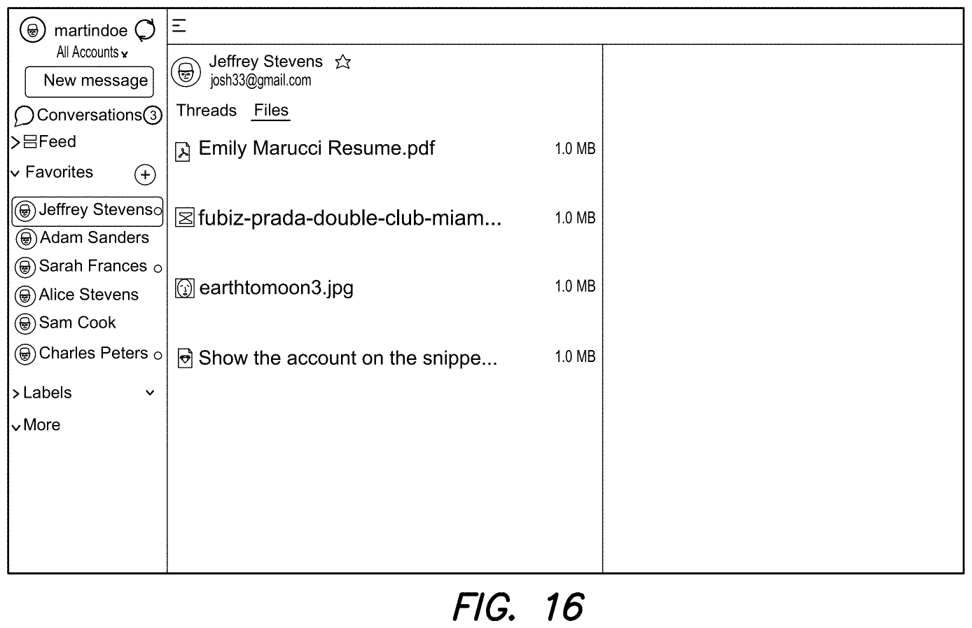

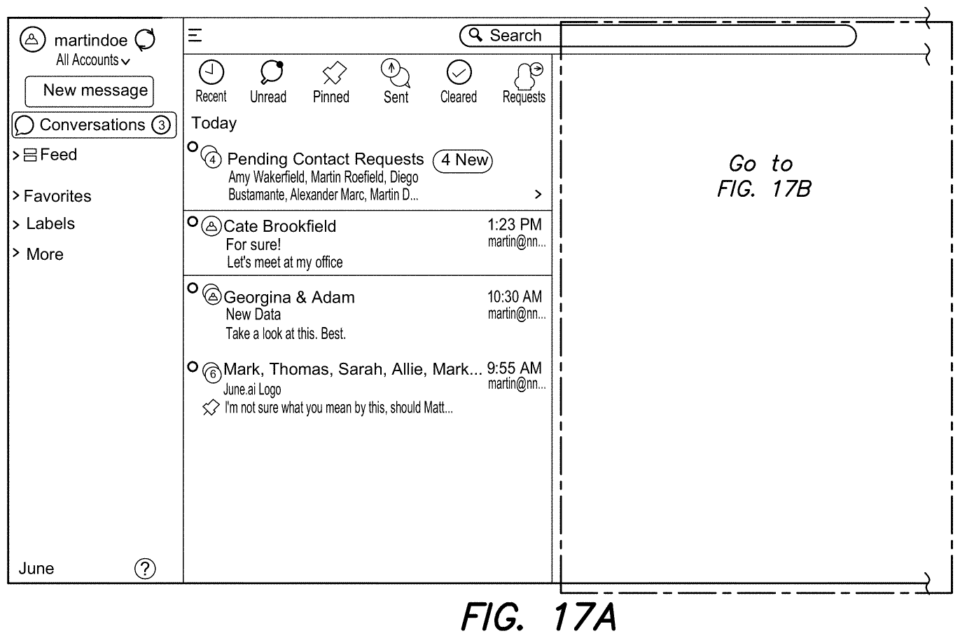

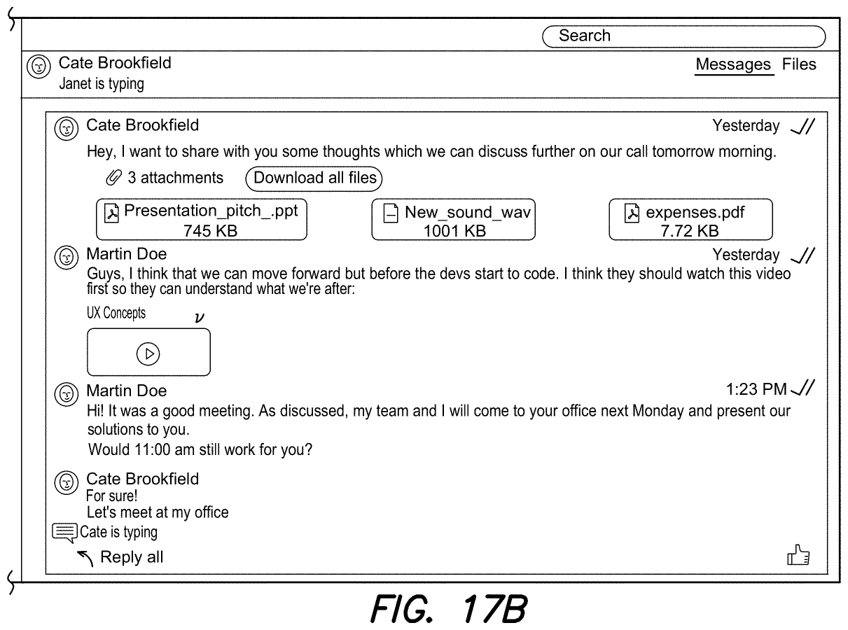

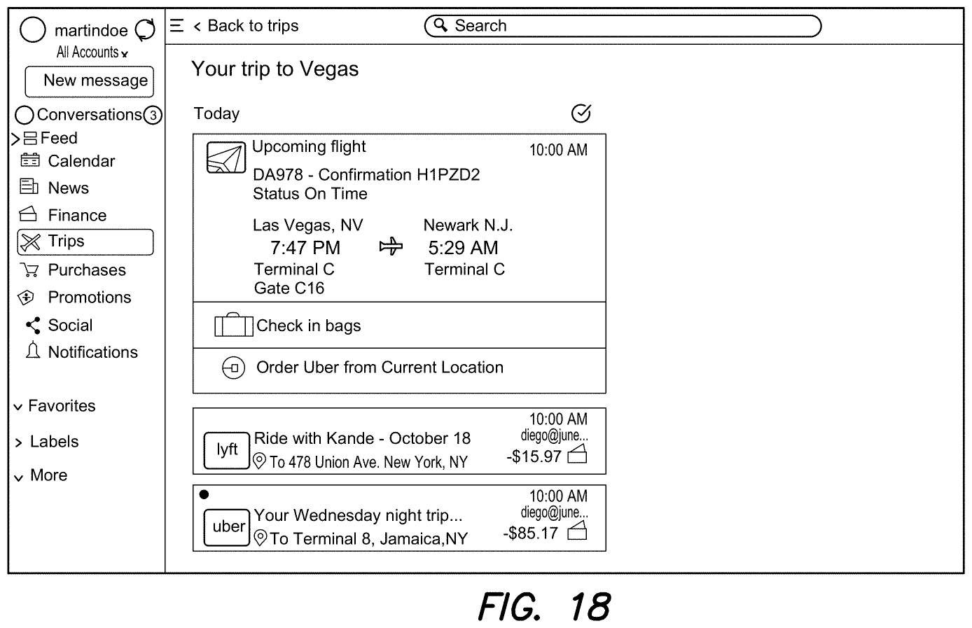

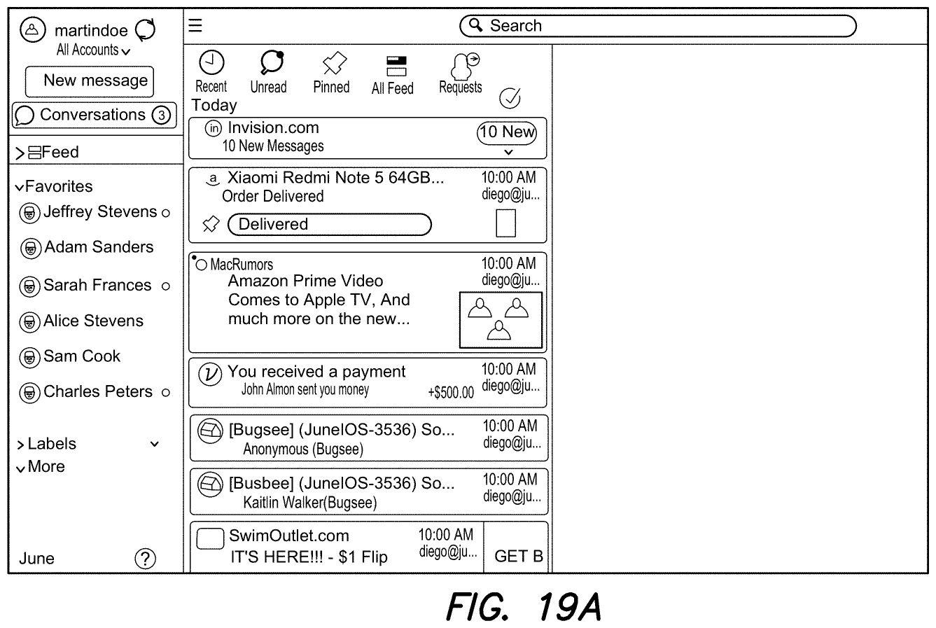

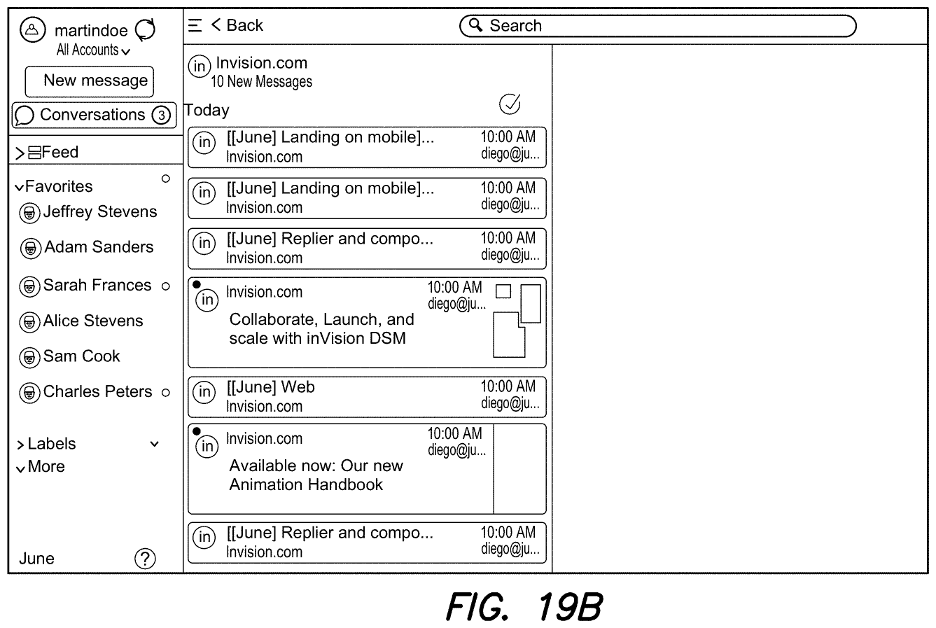

FIG. 13 shows an interface where a message is automatically moved to trash after the contact/recipient is blocked. Future messages from that contact will be moved to trash automatically. FIG. 14 shows the interface for a “Favorite” contact. All messages and files shared with that contact will be listed here making it easier to communicate with this contact. FIGS. 15A-B shows all the files that have been shared between one or more contacts. This view can be accessed through the Rolodex system where the messages are organized based on the participants involved with the messages. FIG. 16 shows the Files view that can be accessed when opening a favorite or a contact profile. This view will list all files shared within only one contact in particular. FIGS. 17A-B shows the interface for June-to-June chat described further below where some of the enhanced messaging system functions can be visible (see when users are typing to each other, see when other users are online, sent receipts, etc.) FIG. 18 shows some embodiments of enhanced options that are possible an API that obtains realtime information and performs automatic actions for the user between those messages. FIGS. 19A-B shows an example where the interface groups all the messages to/from a Person or Company within a given date range (today, yesterday, last week, last month or last year). For example, all the messages that were recently sent by a company where there are lots of messages are grouped by that contact today and the User can perform batch actions on them (mark them all as read, move them all to a folder, archive or delete them).

### Client-Side AI/ML Capabilities

In some embodiments, the system provides the ability to run deep learning neural networks, natural language processing, and machine learning models (from AI frameworks such as TensorFlow, Torch, Caffe platforms, among others) on a client side application (such as the iOS application, web application, or desktop application). Using both the large dataset on the server and personalized data from each user, the system can be configured to provide multiple neural networks that is able to perform automated actions on received information (e.g., through messaging) such as automatically categorize, parse out data from conversations, and detect certain information from emails, communication data, free text, and web pages on the client application. In some embodiments, the system is configured to providing this capability within the client application—this capability is important because the data does not ever leave the client application and the client is provided this capability to perform AI/ML functions of more complex systems. The concept of being able to generate these neural networks using much larger datasets and periodically update them on the client by downloading them to the client allows for much better privacy and superior algorithm improvements over time.

### Introductions System

In some embodiments, components are provided by the system in association with a messaging platform to provide introductions to other users. The introduction system is capable of getting an introduction to connect from a “referring person” with a “potential contact” by sharing an invitation link. In some embodiments, one or more of the introduction process are automated, and a unique linked invitation that manages the connection process is provided in an automated way.

For instance, the system allows the person interested in connecting to create a unique link or invitation that can be sent to any referring contact. The invitation can be shared with any potential contact and it allows them to connect with the person who asked for the referral.

Some embodiments of the system work as follows:
1. After sharing the invitation link to the referring person, the referring person can share that link with the potential contact/s.
2. Then, the potential contact will access the link, input their required contact information (e.g.: email, phone number, username, etc.) and is then be able to accept the invitation to connect.
3. After these steps, both the person interested in connecting and the potential contact receive a message on the platform that introduces them to one another. Another message gets sent to the referring person with a confirmation that the potential contact/s accepted the invite to connect.

For example, John creates a unique link for Martin that allows him to invite to connect with Andrew. Martin receives the link from John and then after Martin agrees, he shares the link with Andrew. Andrew accepts the intro to connect so he clicks on the link and inputs his contact information (email, number, address, etc). After this Andrew receives a message with an invite to connect with John. John receives the same message with Andrew's contact info and now both can connect. Lastly, Martin receives a confirmation that Andrew accepted the invite to connect with John.

### Various Detailed Embodiments and Features

According to various embodiments, the following components and/or features may be implemented in one or more implementations, either alone or in combination with any other features or number of features:

Contacts

As discussed above, various aspects of the system may be related to organizing messages based on contacts. In some embodiments, various aspects may relate to:
One or more algorithms that consolidate names and emails
One or more algorithms and/or a service that retrieves data and profile images from multiple sources that are publicly available on the Internet and self-updates this database

Tags
ability to add user tags to each message, thread, spool, rolodex, favorite, or contact
ability to automatically generate tags based on contact, subject, and message content

Rolodexes

As discussed above, a Rolodex system may be used that organizes messages based on the participants involved with the messages. In one or more embodiments, aspects may relate to:
A contact-based email threading system
An algorithm that threads messages based on the to, from, cc, and bcc fields
An algorithm that is able to consolidate a user's contacts and generate a string that the user understands
Consolidate contacts (e.g., perform a deduplicate of the same people)
Consolidates forwarded or aliased emails
Generates a list of first names or just a single first and last name string
Algorithm that generates a unique identifier based on the participants in a message

Spools

As discussed, aspects relate to a system that organize and present messages to a user based on a thread and participants within the thread. In one or more embodiments, aspects may relate to:
Contact-thread based email threading system
Algorithm that travels up a message chain based on the bottom of the message tree
Spools may be based on the last message and dependent on the referencing messages
An algorithm that detects who was added or removed from a message chain

Favorites Section

Some aspects relate to identifying “favorites” within a section of the interface that may be quickly accessed by the user within the interface. In one or more embodiments, aspects may relate to:
Ability to list one or more contacts and group all the emails with them
Ability to list one or more contacts and group all the emails that are associated with them
Ability to create organizations
Based on the domain name
Organizations have the ability to have public and private groups
Ability to consolidate all the emails of a single contact into a single favorite

Files

Some aspects relate to improved capabilities of managing files associated with messages. It is appreciated that in some conventional systems, it is often difficult to locate files which have been sent using messaging. In one or more embodiments, aspects may relate to:
Ability to show all the files that were sent by a contact (e.g., within a rolodex interface)
Ability to group files such as images, videos or documents by contact and type

Search

Some aspects relate to improved capabilities of search for messages and files associated with messages. In one or more embodiments, aspects may relate to:
Ability to search all the files from emails
Filter by name, message content, category
Ability to search by rolodexes
Ability to search by spools
Ability to search only spools from a contact
Ability to search that contact that was included in any message

June-to-June Chat

Some aspects may relate to improved capabilities of chat functions in an enhanced messaging system. As discussed above, an enhanced chat platform may be provided (e.g., referred herein as a June-to-June chat that couples native “June” clients). Such capability may be determined automatically between clients (such as through a common protocol that identifies client capability). In one or more embodiments, aspects may relate to:
Backwards compatible email system that can perform real time communication (for instance, email is generally not real time and is performed using slower protocols such as SMTP which has long latencies)
show when users are typing to each other
send messages to each other in under 100ms or less (e.g., using websocket connections between clients)
edit messages sent to each other
delete messages sent to each other
consolidate messages that are chat and emails into a single message and thread them appropriately
ability to see when other June users are online
ability to send an email to non-June users and setup a real time chat environment (e.g., using websockets)
ability to send gifs via email
ability to send emojis via email
ability to react to an email (e.g., in a chat channel)
ability to thread emails where you can thread within threads
ability to send direct messages between clients

Feed

Some aspects relate to improved capabilities of managing one or more feeds of messages. It is appreciated that in some conventional systems, it is often difficult to locate files which have been sent using messaging. In one or more embodiments, aspects may relate to:
Ability to Categorize Emails (see categorizer for current capabilities)
Ability to take unstructured email html code and convert them into a standardize structured JSON array
Ability to parse out keywords and place them in structure components to help redesign the email in a consistent predictable way (e.g., for ease of viewing in a particular interface), For instance:
   example extract expiration dates
   example extract tracking numbers and consolidate information from publicly available sources
Ability to utilize computer vision to take classified components that are full rendered to:
   help categorize
   parse out additional text or information that is not in html code
   example: 20% off as an image on a promotional image
   contextualize code with a fully rendered image
Ability to use artificial intelligence algorithms that can generate code based on a training set where code that is mapped to rendered components in html code from emails or webpages. For example:
   ability to dynamically generate emails (generate html/css/js code)
   ability to predict user behavior
   ability to apply this algorithm to general web pages by downloading the entire internet archive
   ability to extract all the possible user action interactions possible by mapping out
      requests and endpoints that are available by the user (GET/POST/etc. . . . )
      ability to redesign a page into a simplified page
      reduce a complicated webpage into an interactive page where you can navigate to other websites
      reduce a complicated webpage into an interactive page where you can submit forms/actions
      reduce a complicated form into a chat bot
   ability to generate a standardized API endpoint for anyone of our internal services to communicate with that is not currently an API
      example website.com does not have an API
      users are able to navigate and place orders
      For example: an algorithm is able to map out website.com and generate an API where the system can now programmatically place orders
Ability to use artificial intelligence algorithms that can navigate webpages:
   ability to automatically fill out forms on web browsers
   ability to click on links
   ability to map out all the links on webpages that are referenced in emails
   ability to map out images, videos, text and other content from webpages that are reference in emails
   ability to perform automated actions using a combination of rules, computer vision, natural language process, machine learning, and automated headless browser technology (examples, but not limited to)
      place an order
      make modifications to an upcoming flight

### Microservices

As discussed above, one or more components are provided that perform finite tasks, some in response to messages received within a feed, interaction with messages, feeds data to other microservices, or the like. Aspects of these microservices may assist in making presentation more clearer for the user, performs automated operations, analysis of incoming emails, or other functions. Such microservices may be exposed to developers, upon which one or more systems may communicate or other applications may be built. Although such microservices may have particular names or functions, they are not limited thereto, and any microservice function may be used with any embodiments and/or other microservice or function referenced herein.

### Microservice/Algorithm to Map Out APIs

In some embodiments, a microservice is provided that is able to crawl certain websites. In some embodiments, a microsystem may be provided that uses deep reinforcement learning to provide rewards for being able to accomplish tasks. In various embodiments, there are two ways of providing such functionality.

In some embodiments, the system programmatically access webpages using simple http libraries and crawl the webpage looking for form fields and mapping how these form fields submissions work. However, it is appreciated that not all webpages are bot friendly. In another implementation, for those systems that are not bot friendly, a headless browser system is provided in the form of an API for a browser system such as Google Chrome, Apple Safari, or other type browser that is able to type and click the way human beings do. Such an API may be applied to a deep-reinforcement learning system to have the create actions, such as an “unsubscribe” button.

For example, the system visits a webpage and simply finds and clicks the unsubscribe button. A control group is, in one implementation, a simple algorithm that would do nothing but random actions. The dependent group uses the deep q algorithm whose input includes looking at buttons within the browser interface and click on them. Another convolution neural network may be used that is able to click on webpages after the webpages are rendered and recognize the interface and click on anything that looks on webpages. The system would be rewarded for being able to visit that website, then clicking on the button that says unsubscribe.

Unsubscribe is just one application within an interface that could be trained and exposed via a microservice. The novel idea behind this would be to use this technology to start automating high volume actions so that programmatically the system could do tasks for users where other websites do not have APIs. For example, the system may “learn” UI aspects that are used to assist the user in performing everyday functions, such as paying utility bills, filling out forms, etc. This is beneficial, as typically these websites usually do not have APIs, and also, most user actions are triggered responsive to a reminder or message (e.g., a monthly invoice reminder). Such a system would be beneficial, as user tasks may be automatically learned and automated. Other microservices may be provided that provide other functions and/or features, alone or in combination with other microservices and/or functions.

Other Microservices
Amazonian

In one implementation, an Amazonian microservices component is provided that parses out emails with finance, deliveries and bill tags and purchases and billing information from unstructured emails into structured JSON arrays.

Atlantis

In one embodiment, an Atlantis microservice calculates basic statistics of single email such as frequency of the sender sending email, word/character count, the dates of received emails and average recurring period for specific contact. It also does sentiment analysis for the content of email.
Ability to detect sentiment of emails based on natural language (positive or negative)
Ability to detect the urgency of emails based on natural language
Ability to predict the sentiment of emails that you're writing and about to send
Ability to detect if you read emails often and rank importance
Ability to determine average reading time based on average human reading speeds
Ability to detect and catalogue how frequently you're receiving emails from a sender, consolidate it based on category—human or machine and predict how often they send messages

Categorizer

In one embodiment, a Categorizer microservice is an classification tool that analyzes the content of email using NLP and machine learning techniques, and tag email messages (or other message types) with related categories
Ability to analyze raw email headers
Ability to analyze natural text in bodies
Ability to associate domains with certain categories

Categories

In one embodiment, a conversation microservice provides communication with human conversation, and may perform functions on behalf of users
Calendar Invite—Calendar invite or update—feeds calendar_invite cal
Bill—Email associated with banking and bills—feeds bill finance
Deliveries—provides delivery confirmation, shipping information—feeds deliveries finance
Travel—any email related to trips feeds travel
Finance—Email related to anything a user can buy, exclude bill and deliveries—feeds finance
Social—Email associated with social networks and outside daily routine of business feeds social
News—Newsletters, blog posts, company updates—feeds news subscript
Promotions—Email trying to sell things, company deals and offers—feeds promotions subscriptions
Notifications—Alerts, email confirmation feeds notifications subscriptions confirmations
More—Any email not belongs to above categories feeds the more construct

Chatter

In one embodiment, a Chatter microservice detects reply/forward patterns for conversation, strips out lines of conversation email and separate them into different sections
Ability to parse out signatures of messages
Ability to parse out only the relevant text from raw messages
Ability to reformat the messages to standardized fonts, colors, etc. to make it easier to read
Ability to parse out quoted messages
Ability to parse out signatures from quoted messages
Ability to reformat the messages to standardized fonts, colors, etc. to make it easier to read from quoted messages

Gutenberg

In one embodiment, a Gutenberg microservice parses out news email with related information
Ability to match the news articles that were sent from that email to RSS feeds
Ability to grab relevant images based on the headlines
Ability to grab the image used from that news article based on headlines
Hancock
Signature parsing system based on matching the contact with the profile used in Titainpointe

Lucybot

In one embodiment, a Lucybot microservice provides an ability to send automated replies—chat bot via email
Ability to make introductions with two strangers using natural language
Example: I'm Lucy, Jiayi Wang's assistant. Jiayi (bcc'ed) would like to introduce you both to each other. You both have some background.
Metamorphic
Ability to take a single link and parse out relevant content
Title of website
Relevant social media links
Relevant images from the website
Relevant text from the website
Relevant videos from the website and embeddable links
Used to show previews

Requests

In one embodiment, a requests microservice prepares backend data for a requests center, which decides whether a message/thread/contact is approved or denied and whether the message/thread/contact should show up in the main section of app. Requests may also contain autowhitelist functionality.

Schedulizer

In one embodiment, a Schedulizer microservice parses out calendar events
Seating Planner
Seating-planner microservices manage the order and other info of participants to show in the thread index.

Sharing

In one embodiment, a Sharing microservice enables share on a June platform and other email/messaging platforms. In one implementation, the sharing component uses a REST API that takes in the original message people want to share (like forward) and generate a sharing card with detailed message view.

Shippingtracker

In one embodiment, a Shippingtracker microservice takes in the tracking number of a package and fetches the detailed tracking information from the developer API the carrier provides.

Summarizer

In one embodiment, a Summarizer microservice summarizes the body of a message, and makes a snippet of the message look neat and clean. The microservice takes in top_message of segmented_html and gets rid of the html styling part as “summary”.

Thales
In one embodiment, a Thales microservice calculates the percentage of read emails of a contact.

Titanpointe

In one embodiment, a Titanpointe microservice uses various APIs to collect the profile pictures of a contact based on its email address, stores the web link to MongoDB and downloads the picture to S3. The microservice also automatically updates the pictures every 30 days.

Traveler

In one embodiment, a Traveler microservice parses out travel emails and upsert travel information based on category of email. For instance, microservices may perform travel functions relating to:
Hotels
Transportation
Rentals

Unsubscriber

In one embodiment, a Unsubscriber microservice may perform unsubscribe functions from subscription emails by sending unsubscribe emails or click unsubscribe links found in an email body

In some embodiments, the microservice may use Artificial Intelligence Computer Vision Algorithms to read, identify, and consolidate with code on the web page to navigate to the site and actually click the unsubscribe buttons
Ability to send unsubscribe emails

WebBeacon

In one embodiment, a WebBeacon microservice includes an email tracking system that uses embedded tracking pixels and wrapped-up links to invisibly track a user's access and behavior on certain content.
Ability to stripe out other email tracking images or code
Ability to list all the images on a given email
Ability to list all the links on a given email
Ability to unwrap links that have tracking code on the links themselves

### Additional Embodiments

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be appreciated that one implementation of the embodiments of the present invention comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A system comprising:
a messaging platform adapted to communicate with one or more message sources, the messaging platform being configured to identify, within the user interface, a plurality of messages in a container based on contact information.

2. The system according to claim 1, wherein the messaging platform being configured to identify, from a message stream, a source of an identified message associated with a conversation with an identified user.

3. The system according to claim 2, wherein the messaging platform is configured to automatically place the identified message in a container based on contact information of the source without any prior user configuration.

4. The system according to claim 1, messaging platform being configured to identify, from a message stream, a source of an identified message associated with a conversation with at least one of a plurality of users and wherein the messaging platform is further configured to identify whether, within a later-sent message within a thread of messages related to the identified message, whether a user was added or deleted to the later-sent message.

5. The system according to claim 1, wherein the messaging platform is configured to discern, from a message stream, a source of an identified message associated with a conversation with an actual person and wherein the messaging platform is configured to automatically place the identified message in a container based on contact information of the source without any prior user configuration.

6. The system according to claim 4, wherein the identified message has a first group listing that identifies users identified in the conversation, and wherein the wherein the messaging platform is configured to automatically place the identified message in a container associated with the particular identified users in the conversation.

7. The system according to claim 6, wherein, in response to receiving a subsequent message in the conversation, wherein a list of identified users that receives the subsequent message is modified, the messaging platform is configured to automatically place the subsequent message in a different container associated with the modified list of users in the conversation.

8. The system according to claim 1, wherein the messaging platform is configured to identify a message originating from a user not previously identified to the system, and in response to the identification, placing the message in a portion of the interface separate from conversations with known users.

9. The system according to claim 8, wherein the messaging platform is configured to respond with an automated message to the user not previously identified to the system.

10. The system according to claim 1, wherein the messaging platform is configured to track subscriptions to message distributions for a receiving user.

11. The system according to claim 10, wherein the messaging platform further comprises a component that is adapted to query the receiving user prior to placing a subscription-based message within a mailbox of the receiving user.

12. The system according to claim 11, wherein the messaging platform further comprises a user interface, responsive to receiving a subscription-based message, queries the receiving user whether the user approves or unsubscribes from the subscription-based message.

13. The system according to claim 1, wherein the messaging platform further comprises a component configured to determine a common communication channel between a first client system and a second client system among a plurality of available communication channels.

14. The system according to claim 13, wherein the plurality of communication channels include at least one of a group comprising an email channel, an SMS channel, an iMessage channel, and an enhanced communication platform channel.

15. The system according to claim 13, wherein selection of a channel among the plurality of available communication channels is based, at least in part, on a stored configuration related to a user to which the first client system communicates with the second client system.

16. The system according to claim 15, wherein the stored configuration is stored in a memory associated with a user of the first client system.

17. The system according to claim 1, wherein the messaging platform is configured to identify, from a message stream, messages that are conversational from messages that are non-conversational.

18. The system according to claim 17, wherein the messaging platform is configured to identify, from the message stream, messages that are conversational from messages that are non-conversational without prior user configuration.

19. The system according to claim 1, wherein the messaging platform is configured to perform an automated introduction to a third party contact.

20. The system according to claim 19, wherein the messaging platform is configured to perform the automated introduction to the third party contact responsive to an email message between a first user and a second user.

21. The system according to claim 20, wherein the messaging platform is configured to send, responsive to the email message between the first user and the second user, a message to the third party contact to accept the introduction.

22. The system according to claim 21, wherein the messaging platform is configured to send an introduction message responsive to an indication that the third party contact accepts the introduction.

23. A method comprising:
providing, in a messaging platform adapted to communicate with one or more message sources, the a system component that identifies, within the user interface, a plurality of messages in a container based on contact information.

24. A computer-readable medium, that when executed on a processor, performs a method comprising:
providing, in a messaging platform adapted to communicate with one or more message sources, the a system component that identifies, within the user interface, a plurality of messages in a container based on contact information.

25. A system comprising:
a messaging platform adapted to communicate with one or more message sources, the messaging platform being configured to identify, from a message stream, a source of an identified message associated with a conversation with an identified user and wherein the messaging platform is configured to automatically place the identified message in a container based on contact information of the source without any prior user configuration.

26. A system comprising:
a messaging platform adapted to communicate with one or more message sources, the messaging platform being configured to identify, from a message stream, a source of an identified message associated with a conversation with at least one of a plurality of users and wherein the messaging platform is further configured to identify whether, within a later-sent message within a thread of messages related to the identified message, whether a user was added or deleted to the later-sent message.

27. A system comprising:
a messaging platform adapted to communicate with one or more message sources, the messaging platform being configured to discern, from a message stream, a source of an identified message associated with a conversation with an actual person and wherein the messaging platform is configured to automatically place the identified message in a container based on contact information of the source without any prior user configuration.
